(19) United States
(12) Patent Application Publication
(10) Pub. No.: US 2015/0127770 A1
(43) Pub. Date: May 7, 2015

(54) Distributed Cloud Disk Service Provisioning and Management

(71) Applicant: PAX8, INC., Lone Tree, CO (US)

(72) Inventor: Klaus J. Dimmler, Colorado Springs, CO (US)

(73) Assignee: PAX8, INC., Lone Tree, CO (US)

(21) Appl. No.: 14/179,389

(22) Filed: Feb. 12, 2014

Related U.S. Application Data
(60) Provisional application No. 61/900,862, filed on Nov. 6, 2013.

(51) Int. Cl. H04L 29/08

(52) U.S. Cl. CPC H04L 67/1097; H04L 67/06
USPC 709/217

(57) ABSTRACT

A distributed cloud disk system includes a computer system that is connected to the Internet or another external network, to which storage services can be remotely provisioned, connected, and monitored by a managed service provider on behalf of the user of the computer system. The system is structured in a hierarchical manner such that all parties involved in supplying or utilizing a given service can interact appropriately with all or some of the provisioning and monitoring processes, while tracking usage information and other data for the purposes of billing and commission payment. This is accomplished by an account with appropriate permissions, which a given party uses to log into the system.

### RELATED APPLICATION

The present application is related to and claims priority of U.S. provisional patent application (“Provisional Patent Application”), Ser. No. 61/900,862, filed on Nov. 6, 2013. The disclosure of the Provisional Patent Application is hereby incorporated by reference in its entirety.

### FIELD OF INVENTION

According to an embodiment of the present invention, the present system and method are generally directed to management of disk services in cloud computing environments, and more particularly, to the management of such services by managed service providers and distributors on behalf of end customers who consume the services.

### BACKGROUND

IT solution providers, managed service providers, value added resellers, and IT consultants, collectively referred herein to as “resellers”, are in the business of selling, managing and administrating a customer's server and workstation computer systems, the networks that connect them, and the application software that runs on them. The emergence of cloud computing has shifted the products involved from computer hardware and software installed on that hardware to subscription-based cloud services. Managing subscription services rather than hardware and software installed locally provides new challenges for this industry, particularly in the areas of administration, control and monitoring.

An important cloud subscription service that resellers provide to their customers is cloud disk. Cloud disk is a subscription service for disk in the cloud. On the customers' local system, cloud disk can be mapped to a local directory structure, allowing the customer to drag files into a directory that transfers the files to the cloud disk. Mapped drives can also be used directly by applications that run on the customers' computers. Customers pay only for the disk that they use, and virtually infinite disk space is available to the customer. Besides the promise of never running of out of disk space, advantages include automatic backup of files, the capability to share the files with others, a high level of security, and the reliability matched only by high-end data centers.

In order to provide this service, the reseller must connect to the server or work station that needs to be mapped. This can be done by visiting the customers' premise and logging directly into the physical machine. It can also be accomplished remotely by logging into the computer in question with emulation software that permits the computer to be controlled remotely. Still, the reseller must log into the screen of every computer of every customer that needs to be mapped, of which even a single customer can be expected to have many. The reseller must also track which systems are mapped to which cloud drive. Besides requiring many individual logins, tracking and monitoring the cloud disks becomes a significant challenge, particularly as the number of systems under the reseller's care increases.

Resellers sometimes purchase and maintain cloud services directly from the vendor that supplies the service, and resell that service to end-customers, as discussed above. At other times, however, a reseller A will sell these cloud services to another reseller B. Reseller A might aggregate many cloud services, thereby providing to Reseller B the benefit of “one stop shopping.” In this case, Reseller A is known in the industry by such names as “Distributor”, “Value Added Distributor”, or “VAD”. When a distributor sells product to a Reseller B, who in turn sells to Reseller C, then reseller C is known as a “downstream reseller.” A downstream reseller could sell to yet another downstream reseller, who in turn sells to an end-customer. In this sense, there is a supply chain that delivers cloud services from the vendor to the end-customer through a distributor and any number of resellers.

In such situations, an end-customer might be responsible for maintaining its own cloud disk, Reseller B might be responsible for maintaining the end-customer's cloud disk, Reseller A might be responsible for maintaining the end-customer's cloud disk on behalf of Reseller B, or the VAD might be responsible for maintaining the end-customer's cloud disk.

At times, the end-customer may choose to change the provider from which they purchase their cloud service for a wide variety of motivations including lower costs, improved service, or improved business relationship. Movement from one service provider to another often presents a challenge because of the need to migrate large amounts of data from the systems under the control of a previous provider to a new one. Such data migration is often even further complicated by mixing data and the application. For example, moving Microsoft Exchange data involves exporting and importing data from the application rather than simply moving a set of files directly from one disk to another.

Therefore, it would be desirable to provide a means to remotely map and monitor multiple cloud disks on behalf of multiple customers or on behalf multiple downstream resellers who sold the service to the end-customer, and to provide mechanisms to minimize and simplify movement of data when the end-customer changes service providers.

### SUMMARY OF INVENTION

According to an embodiment of the present invention, the present system and method include a computer system that is connected to the Internet or another external network, to which storage services can be remotely provisioned, connected, and monitored by a managed service provider on behalf of the user of the computer system. The system is structured in a hierarchical manner such that all parties involved in supplying or utilizing a given service can interact appropriately with all or some of the provisioning and monitoring processes, while tracking usage information and other data for the purposes of billing and commission payment. This is accomplished by means of an account with appropriate permissions, which a given party uses to log into the system.

In one embodiment, accounts on the system are configured to have administrative capability over other accounts, providing a range of capabilities that can be performed on behalf of those accounts. Such “on behalf of” capabilities include provisioning services, changing the reseller for a given user, deleting users, and changing orders or prices of services.

In another embodiment, the system is constructed to provide a separation between the application code and the storage component in a manner that allows different applications to interact with the same storage component without requiring a movement of the physical data.

### DESCRIPTION OF THE DRAWINGS

FIG. 1 is a block diagram illustrating the components of a cloud disk administration system according to an embodiment of this invention.

FIG. 2 illustrates the communications flow in establishing and monitoring the disk cloud service from the centralized dashboard.

FIG. 3 is a block diagram illustrating the functions of the agent program residing on a computer system.

FIG. 4 is a block diagram illustrating further functionality of the dashboard.

FIG. 5 illustrates the concept of separating the data component from the executable component of a program.

FIG. 6 illustrates the benefits of separating application from data.

FIG. 7 illustrates an example of how separation of application and data greatly simplifies migration.

FIG. 8 illustrates another example of how separation of application and data simplifies changing a cloud service from one vendor to another.

FIG. 9 illustrates the concept of executing a process on a file before it is stored in the Cloud Disk.

FIG. 10 is an illustration of the permission hierarchy of the system.

### DETAILED DESCRIPTION OF PREFERRED EMBODIMENTS

Embodiments of the invention include a novel approach for IT Solution Providers to centrally control, monitor, and connect cloud disks from various vendors that reside on various physical work stations, physical servers, virtual servers, or virtual desktops belonging to end-customers. The invention will now be described in detail making reference to the accompanying drawings.

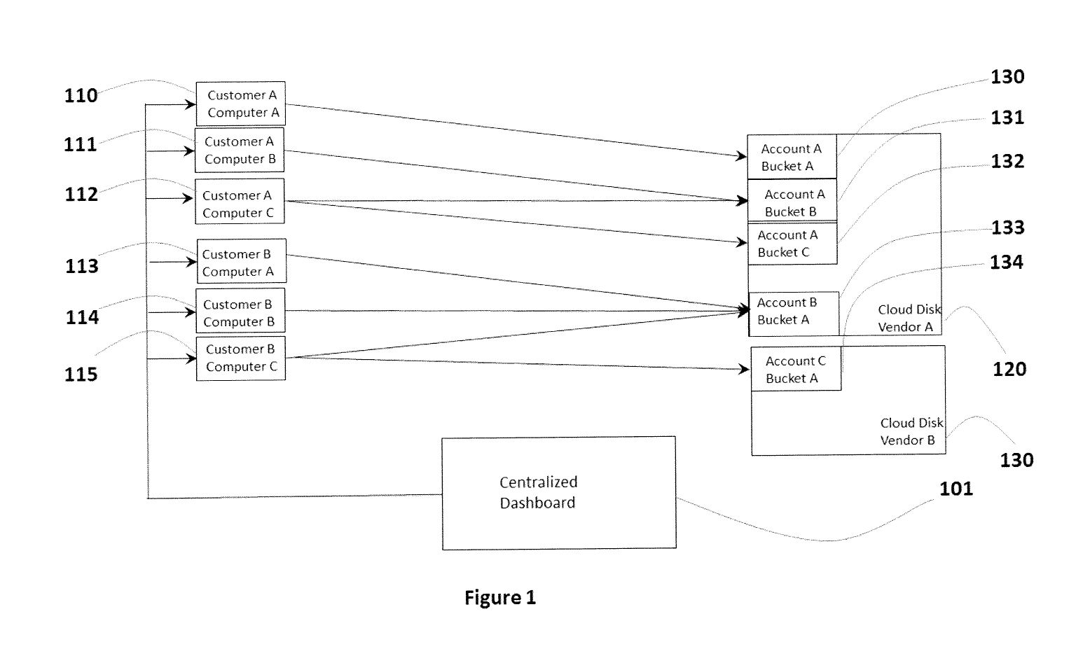

FIG. 1 is a block diagram illustrating the components of a cloud disk administration system according to an embodiment of this invention.

Centralized Dashboard 101 of FIG. 1 is a software application residing on a local computer or a cloud computing environment that is networked to any number computing systems 110-115 that are to be connected to a Cloud Disk System 120 or 130, provided by Vendor A and B respectively.

Computer Systems 110-115 of FIG. 1 represent any computing devices to which one might want to map external disk space, including servers, workstations, client computers, laptops, and mobile devices. Such computing devices include physical devices, as well as services provided in a cloud computing environment, such as virtual servers, virtual desktops, and applications. Some set of these computing devices could be connected to each other via a wired or wireless network connection, or could be stand-alone. It is assumed that these devices would have some means of connecting to Cloud Disk 120 or 130 and to Centralized Dashboard 101, such connection being a private network, a public network, or the Internet.

Cloud Disk 120 and 130 in FIG. 1 represent two cloud disk vendors A and B. Cloud Disk is any disk array to which another computer can connect, including disk residing at a data center, a private cloud, a hybrid cloud, or a public cloud. In this embodiment, cloud disk is a service provided by a vendor that allows users with an account to deposit data files on remote disks, charging the user for the disk space that they use. Such disk space can come in a variety of levels of performance at corresponding prices per unit volume, including flash memory, magnetic memory with redundancy, or magnetic disk without redundancy. Each account can establish multiple buckets, each bucket representing a block of disk space that can be mapped separately by one or more devices. Dashboard 101 has the capability of mapping multiple devices belonging to multiple customers to multiple cloud vendors. It should be noted that though FIG. 1 illustrates just two cloud disk vendors, the invention pertains to any number of cloud disk vendors.

In FIG. 1, for example, Customer A has established buckets 130-132, mapping device 110 to bucket 130, device 111 to bucket to bucket 131, and device 112 to bucket 131 and 132. When more than one device is connected to a single bucket, then the two devices can share the data that resides in that bucket. Therefore, device 111 and device 112 share the data in bucket 131. Likewise, devices 113, 114, and 115, all belonging to Customer B, share bucket 133, consequently enabling sharing the data in bucket 133 among all those devices.

In a further example, FIG. 1 illustrates a single device 115 belonging to Customer B that is mapped to bucket 133 and bucket 134 on cloud disk 120 and 130, respectively, each being provided by a different vendor. In addition, device 113 and device 114 are also mapped to bucket 133, enabling devices 113, 114, and 115 to share the data in that bucket.

Referring again to FIG. 1, Dashboard 101 connects to an agent program that is installed and resides on each of devices 110-115. An agent program is memory resident software code that has the permissions and capability to control certain functionality of the device, including connecting the file system with a mapped external disk drive.

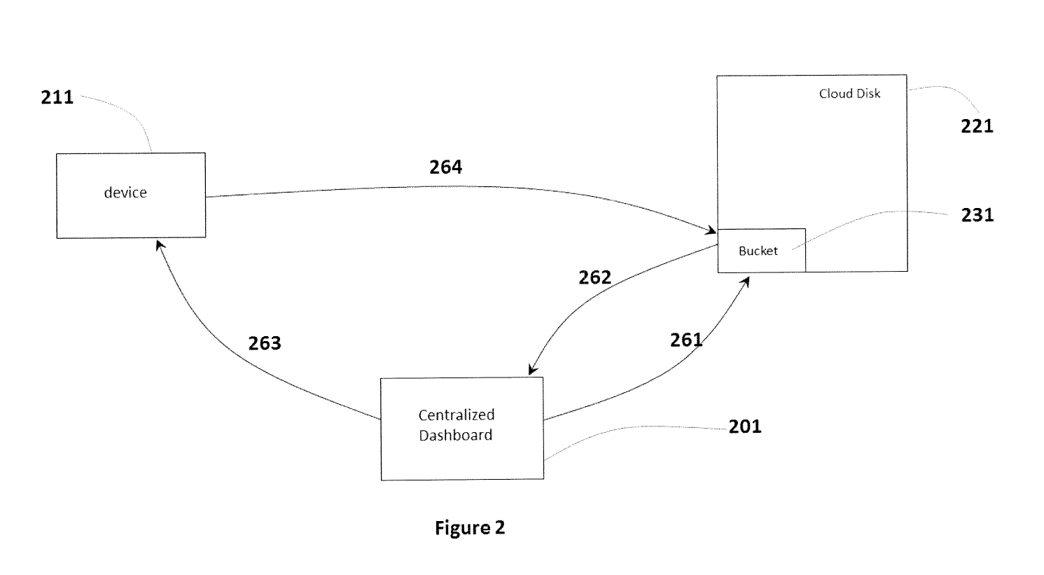

FIG. 2 illustrates the communications flow in establishing and monitoring the disk cloud service between Dashboard 201, device 211, and bucket 221 on cloud disk 231. The process begins with request 261 which is made on Dashboard 201 to establish a cloud disk bucket 231 on Cloud Disk 221.

In one embodiment, the service account corresponding to bucket 231 is opened under the name of the reseller on behalf of the reseller's customer. Dashboard 201 associates this bucket with the particular customer and keeps track of usage. In this case, the Cloud Disk vendor bills the reseller, and the reseller bills the customer utilizing the usage data being tracked by Dashboard 201. In another embodiment, the Dashboard establishes the account under the customer's name, in which case the Cloud Disk vendor would bill the customer directly.

In response to request 261 of FIG. 2, the Cloud Disk system 221 responds with credential information 262. This credential information 262 is stored on Dashboard 221 for later use. Dashboard 201 will then send a request 263 to an agent program residing on customer device 211 to establish a mapping of a drive letter to bucket 231. The agent program was previously installed on device 211, and grants access and permissions for request 263 to be executed. In addition, the agent program has the wherewithal to monitor and manipulate the file system on device 211. Using one of the agent's capabilities, namely to map a drive letter to an external disk, the file system of device 211 is connected to a bucket utilizing credential information 262. At this point, a user of device 211 can establish folders or drag and drop data files into the drive letter that was established, thereby transferring and storing that content in bucket 231.

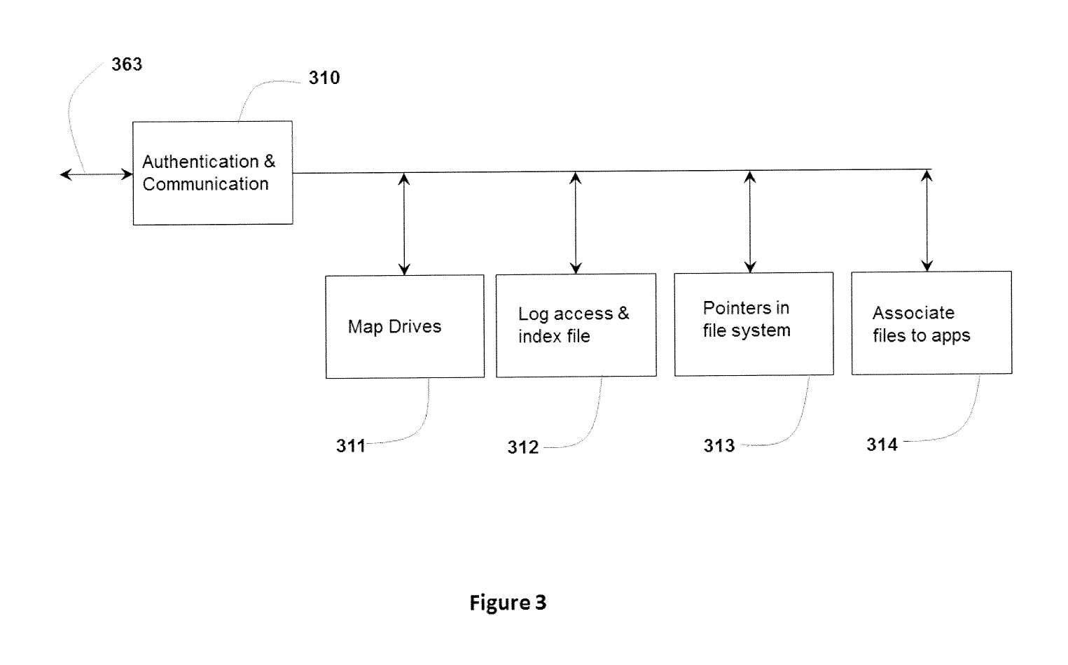

FIG. 3 is a block diagram illustrating the functions of the agent program residing on device 211 in more detail. Request 363 originates from aforementioned Dashboard, and is received by the Authentication and Communication module 310 of the agent program. One type of request is to connect a letter drive to an external disk, such operation being performed by the Map Drives module 311. Another type of request can associate an application on the local device with a bucket on a cloud disk, such operation performed by module 314. Other functions of the agent program are performed by additional program modules.

Program Agent module 312 of FIG. 3 logs touches to files, including read access, modification, transfer, or deletion of all files on the cloud list. In addition, module 312 maintains an index of files that tracks to which cloud drive any given file has been transferred. Module 313 inserts pointers for files that were transferred to a cloud disk in the local file system, which, when selected, will point to the file and provide information regarding its whereabouts.

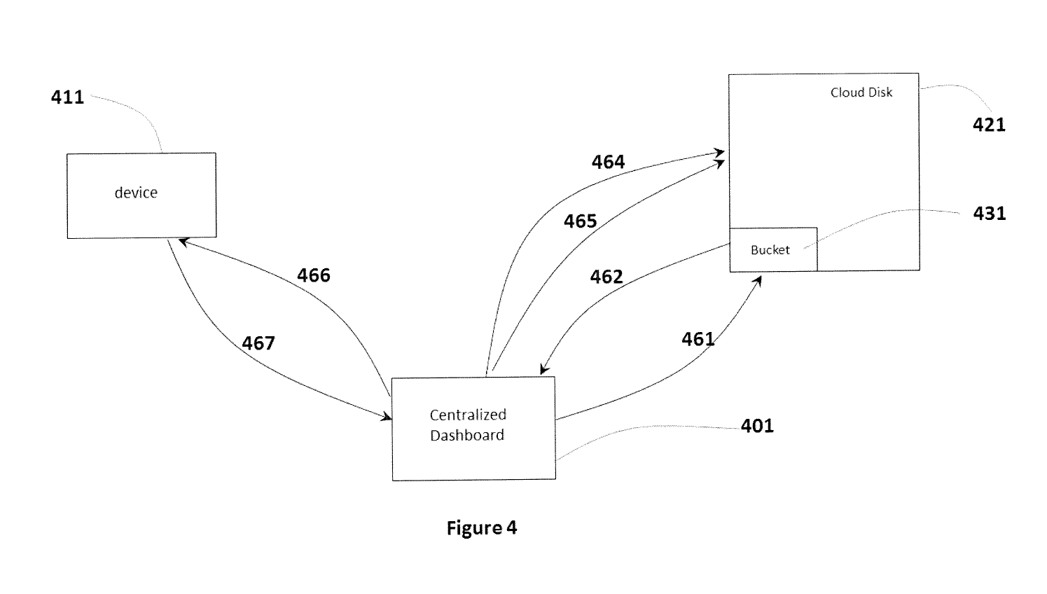

FIG. 4 is a block diagram illustrating further functionality of Dashboard 401. Request 461 can be sent to a bucket 431 on Cloud Disk 421 on behalf of any account being monitored and controlled by Dashboard 401, in response to which information 462 about the bucket is returned. Such information includes disk usage and other parameters that are appropriate for status monitoring and billing.

Request 464 of FIG. 4 can be sent to the administration system of Cloud Disk 421, typically via an Application Interface Protocol (API), in response to which information 465 is returned. Such information includes billing and usage data, which is used for the purposes of billing and monitoring.

Request 466 of FIG. 4 can be sent to the customer device 411 to request information 467 that has been gathered by the agent program that resides on that device. Such information 467 includes mapping information produced by module 311 of FIG. 3, log files and index produced by module 312 of FIG. 3, and applications that have been associated with cloud disks produced by module 314. In addition information 467 could include other data relevant to the device including operating system, version numbers, hardware information, and information about the software applications running on that device.

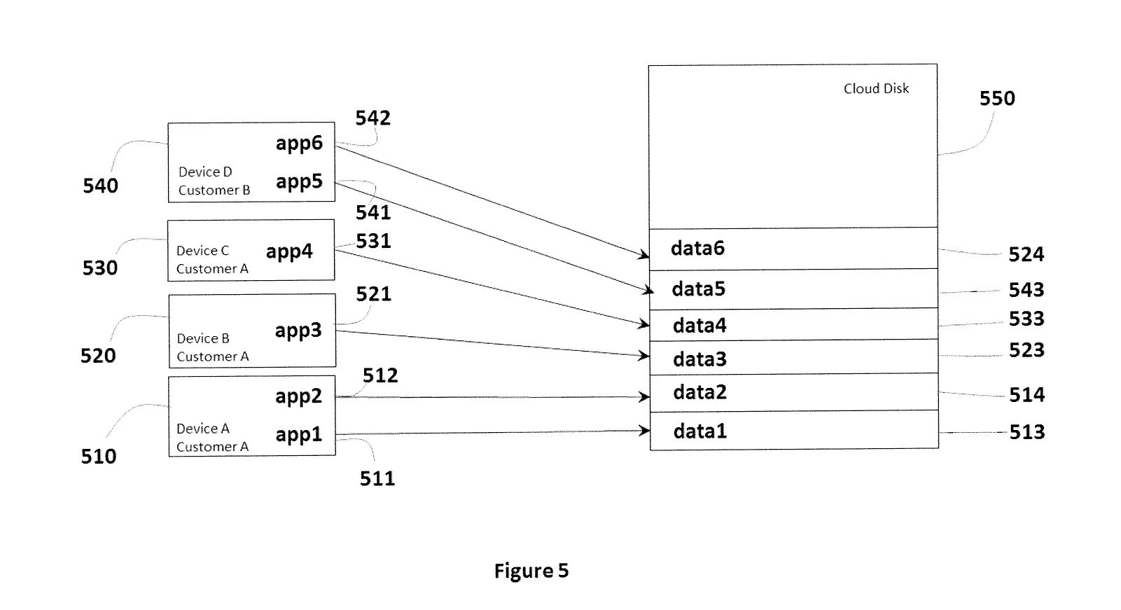

FIG. 5 illustrates the concept of separating the data component from the executable component of a program. Devices 510, 520, and 530 belong to Customer A, and run applications 511/512, 521, and 531, respectively. Device 540, running applications 541 and 542, belongs to Customer B. In each case, the data that corresponds to these applications is stored on Cloud Disk 550. Specifically, application 511 stores data in bucket 513, application 512 in bucket 514, application 521 in bucket 523, application 531 in bucket 533, application 541 in bucket 543, and application 542 in bucket 524.

The structure described in FIG. 5 permits Customer A, or the reseller who administers Customer A's systems, to backup all data from multiple applications in a single process by making a copy of a block of data consisting of buckets 513, 514, 523, and 543 of FIG. 5.

Additionally, this structure allows a reseller to back up the data of multiple customers. A reseller administering device 540 of FIG. 5 belonging to Customer B and devices 510, 520, and 530 belonging to Customer A, could back up the data of both customers in a single process by making a copy of the block of data consisting of buckets 513, 514, 523, 533, 543, and 524.

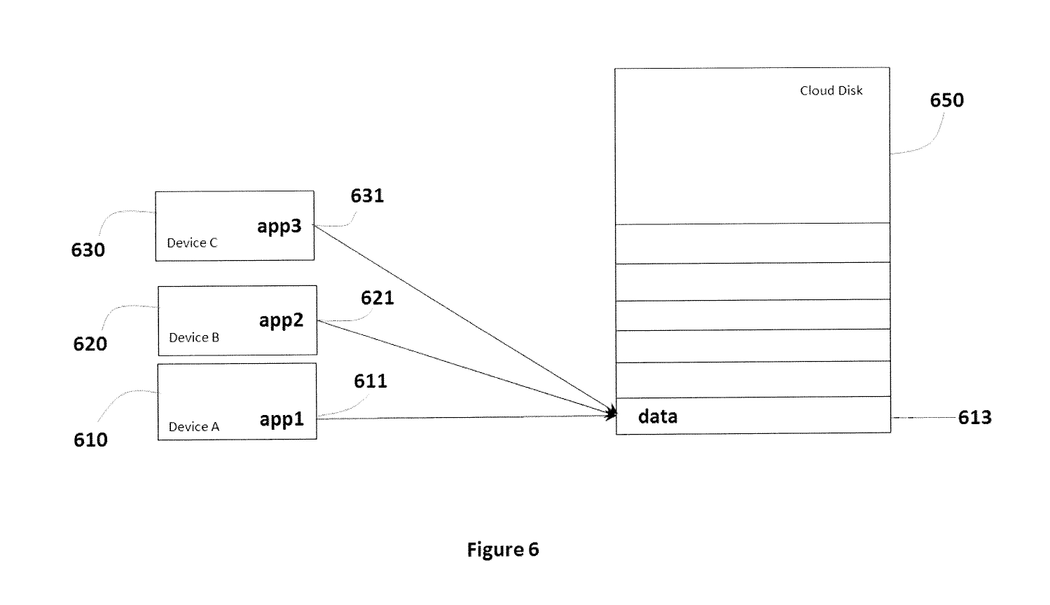

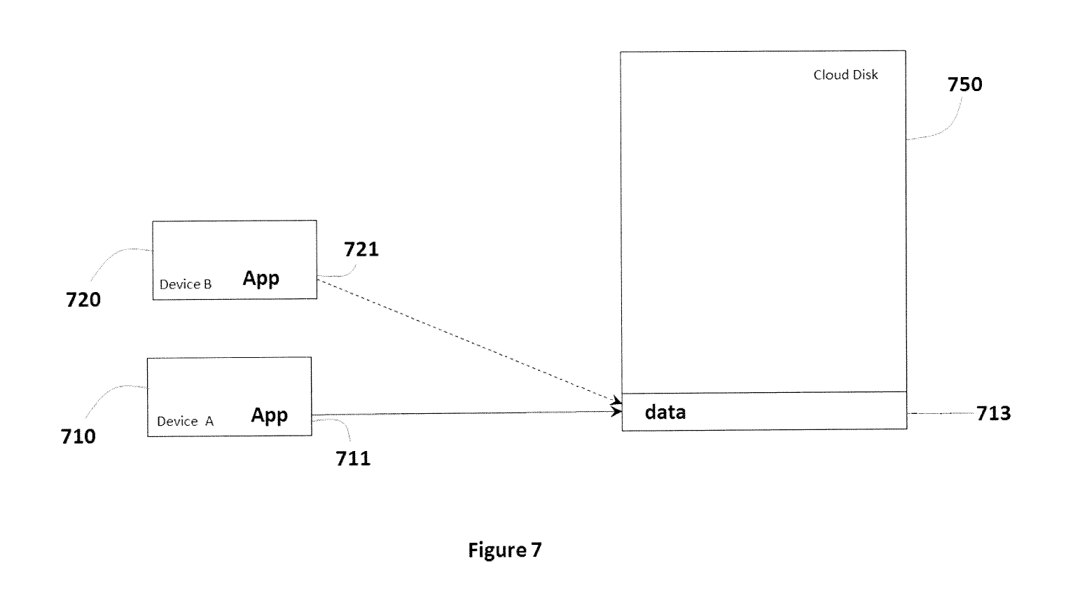

FIG. 6 illustrates another benefit of separating application from data. Applications 611, 621, and 631 share the same data 613. Data 613, for example, might represent contact information. Application 611 running on device 610 might use data 613 as a telephone list, while application 621 running on another device 620 might use it to create a mailing list, while application 631 running on device 630 might use it for an entirely different purpose using the same data. Separating the application from the data, and storing the data in a Cloud Disk can also be used to simplify migration. Some applications, a such as Microsoft Exchange, require a cumbersome and time consuming process of exporting the data from an application, installing the application on another computer, and then importing that data into that new installation. FIG. 7 illustrates how such migration is greatly simplified. Device 710 runs application 711, and stores its data contents in bucket 713 of Cloud Disk 750. Migration of that application to device 720 comprises installing the app 721 on the device, and pointing it to the same data 713. In this fashion, the application has been migrated from device 710 to 720 without the substantial task of exporting and importing data.

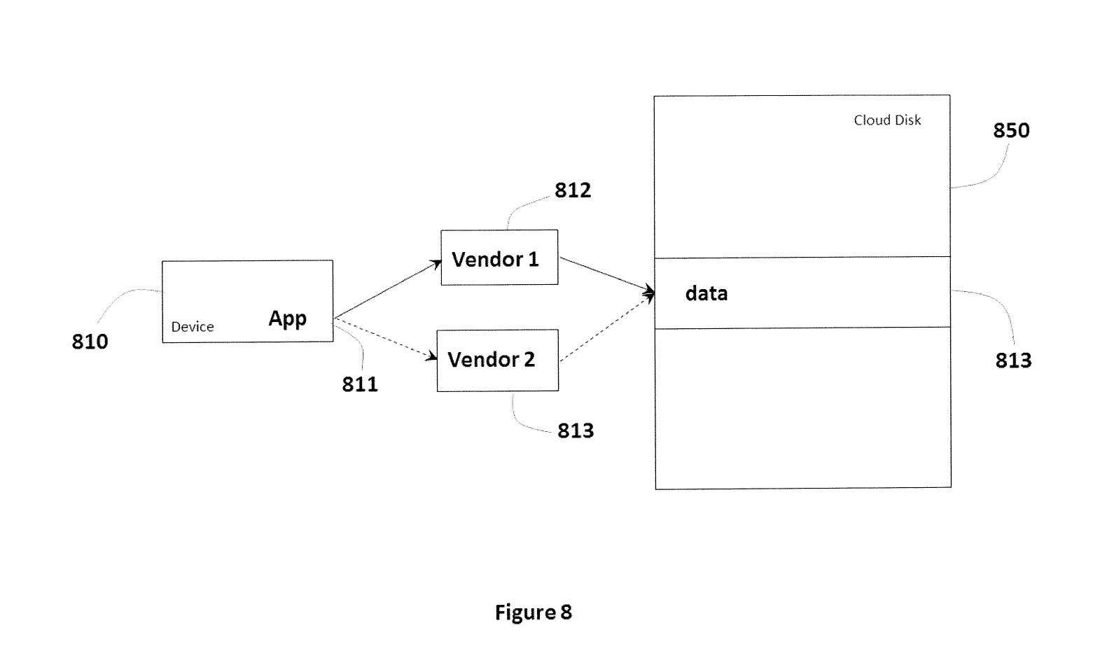

FIG. 8 illustrates a related benefit of the application and data separation in hosted applications. Some applications are hosted by vendors, such as Hosted Exchange, wherein the vendor offers services on the basis of “Software as a Service” (SaaS). When a customer changes from one vendor to another, it is generally necessary to migrate the data from the systems of one vendor to the new vendor. As shown in FIG. 8, when data is stored on a separate Cloud Disk, then the data does not need to be physically moved. App 811 running on device 810 is connected to Vendor 812 to provide a service. Vendor 812 separates the application from the data by storing the data in Cloud Disk 850. If the Customer owning device 810 would like to change vendors to Vendor 813 instead, the data can simply be repointed to the same Cloud Disk 850.

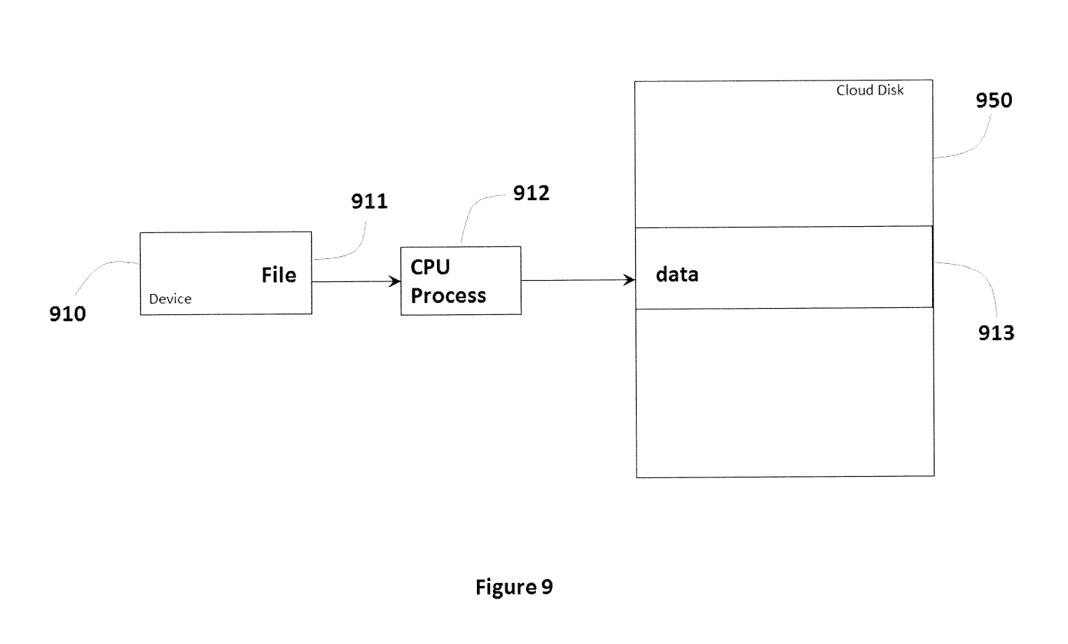

FIG. 9 illustrates the concept of executing a process on a file before it is stored in the Cloud Disk. A file 911 residing on device 910 is dropped into mapped drive or folder on device 910 that has been configured as a “Smart Folder.” This folder is associated with bucket 913 on Cloud Disk 950, but is first transferred to a disk associated with CPU 912 to be operated upon by a process running on that CPU. The resulting file is then transferred into bucket 913 on Cloud Disk 950. In the preferred embodiment, CPU 912 is a virtual server or virtual desktop in the cloud, preferably one that has a fast connection between CPU 912 and Cloud Disk 950. In another embodiment, the process of CPU 912 could be an application that runs as part of the Agent Program that resides on device 910.

Examples of the process on CPU 912 include operating on data within the file such as de-duplicating data, summarizing data, filtering data, or compressing data. Another example of the process on CPU 912 is changing the file format appropriate for a given application, such as conversion of email, word file, text files, and picture files to a pdf format so a pdf application will successfully read all files in that folder. Another important example is the conversion of a backup file of a physical server to a backup file format of a virtual server, thereby enabling the possibility of establishing a virtual server in the cloud identical to a physical server using backup files made for the physical server.

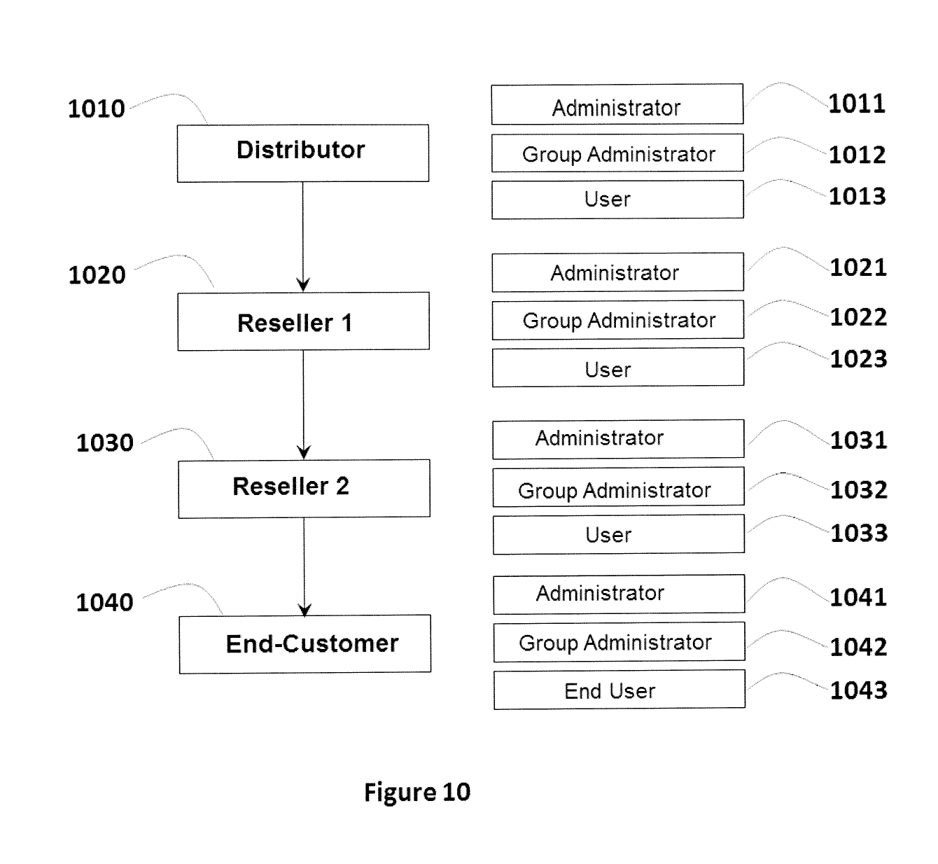

FIG. 10 is an illustration of the permission hierarchy of Dashboard 401 in FIG. 4, with which system functions are administered. In this system, an upstream reseller can administer the accounts of all of his downstream accounts. Each reseller level consists of a hierarchy of permissions as well. Accordingly, End-user account 1043 of End-Customer 1040 can administer only his own accounts. Group Administrator 1042 of End-Customer 1040 can administer the accounts of a group of users belonging to End-Customer 1040. Administrator 1041 of End-Customer 1040 can administer all accounts belonging to End-Customer 1040.

Referring again to FIG. 10, Administrator 1031 of Reseller 1030 can administer all the accounts of End-Customers that have been sold by Reseller 1030. Additional accounts 1032 and 1033 of Reseller 2 can be set up with various administrative permission limitations or limitations to a set of End-Customers. User 1033 of Reseller 2, for example, could be set up to have administrative access to only a subset of End-Customer 1040 accounts that belong to Reseller 1030. Similarly, this same relationship exists for upstream resellers. Administrator account 1011 of Distributor 1010 of

FIG. 10 has access to all accounts. Various account types 1012 and 1013 belonging to Distributor 1010 can be set up with lesser permissions. It should be noted that though FIG. 10 shows only two levels of resellers, namely Reseller 1020 and 1030, this concept can apply to any number of resellers in the chain. Similarly, though FIG. 10 shows only 3 different types of accounts per level, any number of account types could be defined.

While there have been described above the principles of the present invention in conjunction with specific systems and methods of operation, it is to be dearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicant hereby reserves the right to formulate new claims to such features and/or combinations of such features during the prosecution of the present application or of any further application derived therefrom.

What is claimed is:

1. A method comprising:
providing a disk at a first location serving as a cloud disk service;
providing a computer system residing at a second location; and
providing a processor at a third location configured for remotely transferring files between the disk at a first location and the computer system at a second location.

2. The method of claim 1, further comprising a set of user accounts that provide access to processor at the second location with permissions to move files between the first location and second location, and to enable mechanisms for other user accounts to perform these functions.

3. The method of claim 1, further comprising a first set of user accounts that provide access to the processor at the third location with permissions to set up mechanisms to enable users to move files between the first location and the second location.

4. The method of claim 3, further comprising a second set of user accounts, each of which have the permissions and capabilities to perform the functions of a specific set of first set of accounts.

5. The method of claim 3, further comprising an nth set of user accounts, each of which have the permissions and capabilities to perform the functions of a specific set of (n−1)th set of accounts.

6. The method of claim 5, further comprising administrative capability of the nth set of accounts over a specific set of (n−1)th set of accounts.

7. The method of claim 6, wherein the administrative capability of the nth set of accounts includes the ability to change the permissions, capabilities, and associations of a specific set of (n−1)th accounts.

8. The method of claim 6, wherein the administrative capability includes mapping a drive at the second location.

9. The method of claim 8, wherein the administrative capability includes attaching one or more applications to one or more mapped drives such that the output of a given application is sent to a specified mapped drive.

10. A method of claim 1 further comprising a processor configured to run a first application, interacting with a remote disk, wherein the data on the remote disk can be utilized with a second application.

11. The method of claim 5, wherein the processor at the second location maintains an index of all files transferred between the first location and second location, and wherein that index is available for use at the third location.

12. The method of claim 5, wherein the processor at the second location maintains a log of all files transferred between the first location and second location, and wherein that log is available for use at the third location.

13. The method of claim 5, wherein the processor at the second location inserts pointers in place of all files moved, which point and retrieve the file at the third location when that pointer is invoked.

14. The method of claim 5, wherein a single cloud disk block at the third location is divided into smaller blocks, each of which has permissions reflected by the account permission defined at the third location.

15. The method of claim 10, wherein a single cloud disk block is divided into smaller blocks, each of which connect with one or more applications with permissions reflected by the account under which that application is running.

16. The method of claim 14, wherein usage of each smaller block is tracked individually for the purposes of billing and accounting.

17. The method of claim 10, wherein an application provided by a first provider connected to given block of cloud disk under the control of a given account can be replaced by an equivalent application provided by a second provider while utilizing data on the same block of cloud disk under the same control.

18. The method of claim 10, wherein a second application can utilize the same data residing on the same data store that was generated or modified by a second application.

19. A method comprising:
providing a directory at the first location that is linked to a processor residing at the second location; and
providing a storage device residing at a third location,
wherein when a file is placed in the directory at the first location, it is transferred to the processor at the second location, and the output of which is transferred to the storage device at the third location.

20. The method of claim 19, wherein the file submitted at the first location produces a file containing the same information at the third location in an altered pre-defined data format.

21. The method of claim 19, wherein the file submitted at the first location is a backup image file of a given type, and the file produced at the third location contains the same information in the form of another image type, applicable for backup onto another type of operating system.

22. A distributed cloud disk services system comprising:
a disk at a first location serving as a cloud disk service;
a computer system residing at a second location; and
a processor at a third location configured for remotely transferring files between the disk at a first location and the computer system at a second location.
